(19) United States
(12) Patent Application Publication
(10) Pub. No.: US 2024/0356211 A1
(43) Pub. Date: Oct. 24, 2024

(54) ANTENNA STRUCTURE AND ELECTRONIC DEVICE

(71) Applicant: Nanning FuLian FuGui Precision Industrial Co., Ltd., Nanning (CN)

(72) Inventors: MAO-KAI HSU, New Taipei (TW); RU-YAN LI, Shenzhen (CN)

(73) Assignee: Nanning FuLian FuGui Precision Industrial Co., Ltd., Nanning (CN)

(21) Appl. No.: 18/208,797

(22) Filed: Jun. 12, 2023

(30) Foreign Application Priority Data
Apr. 21, 2023 (CN) 202310443905.5

(51) Int. Cl. H01Q 1/52; H01Q 1/50; H01Q 9/42

(52) U.S. Cl. CPC H01Q 1/523; H01Q 1/50; H01Q 9/42

(57) ABSTRACT

An antenna structure includes: a first antenna and a second antenna both electrically connected to a grounding part for signal transmission and reception. The structure also includes an isolation element arranged between the first antenna and the second antenna to adjust an antenna bandwidth and a current path between the first and the second antennas. The adjustment increases the degree of isolation between the antennas, meeting preset antenna bandwidth requirements, and reducing ground edge current conduction interference, mutual interference between the first and the second antennas, and increasing the degree of isolation.

### FIELD

The present disclosure relates to a technical field of communication, in particular to an antenna structure and electronic equipment.

### BACKGROUND

With the development of the Internet, Wi-Fi™ has become an essential part of people's work and life. With the increasing popularity of wireless terminals such as mobile phones and tablet computers, it has become common to have multiple wireless terminals at hand. The significant increase in the number of devices accessing wireless networks has resulted in higher demands for bandwidth, concurrency, lower latency, etc. However, most antennas currently available with frequency bands ranging from 2.4 to 2.5 GHz and 5.15 to 5.85 GHz, which no longer meet the bandwidth requirements. It has become an important issue to add more to expand bandwidth and meet the requirements of smaller size and higher degree of isolation.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is an optional hardware structure schematic diagram of an embodiment of an electronic device of the present disclosure;

FIG. 2 a structural schematic diagram of an embodiment of an antenna structure of the present disclosure;

FIG. 3 is a schematic diagram of a simulation curve of return loss of the antenna structure of the present disclosure and degree of isolation between the first antenna and the second antenna;

FIG. 4 is a schematic diagram of an actual test of the return loss of the first antenna of the antenna structure of the present disclosure;

FIG. 5 is a schematic diagram of an actual test of the return loss of the second antenna of the antenna structure of the present disclosure;

FIG. 6 is a schematic diagram of an actual test of the degree of isolation between the first antenna and the second antenna of the antenna structure of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one”.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

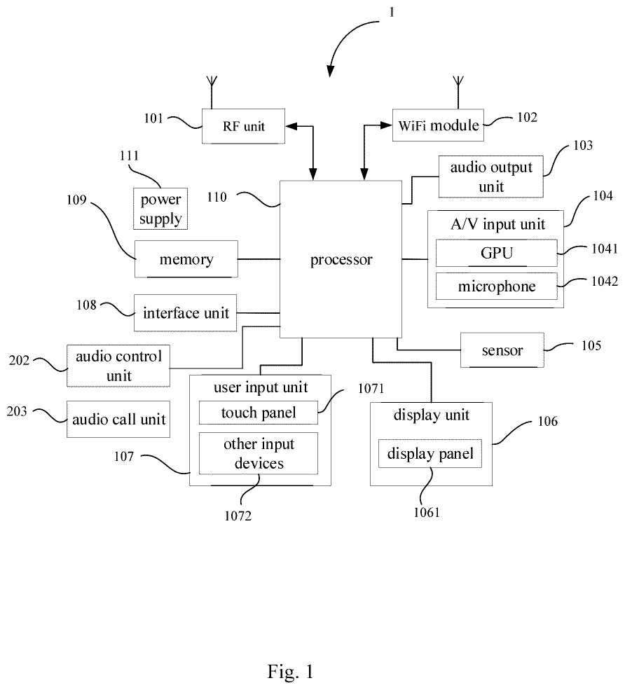

Please refer to FIG. 1, FIG. 1 is an optional hardware structure schematic diagram of various embodiments of the electronic device of the present disclosure.

The electronic device 1 can include: RF (Radio Frequency) unit 101, Wi-Fi™ module 102, audio output unit 103, A/V (Audio/Video) input unit 104, sensor 105, display unit 106, user input unit 107, interface unit 108, memory 109, processor 110, power supply 111, audio control unit 202, and audio call unit 203. Those skilled in the art can understand that the electronic device structure shown in FIG. 1 does not constitute a limitation on electronic devices. Electronic devices can include more or fewer components than shown in the figure, or combinations of certain components, or different component arrangements.

The following is a specific introduction to each component of the electronic device in conjunction with FIG. 1:

The RF unit 101 can be used for sending and receiving information or receiving and sending signals during a call. Specifically, after receiving the downlink information of the base station, it is processed by the processor 110; in addition, the uplink data is sent to the base station. Generally, the RF unit 101 includes, but is not limited to, an antenna structure, at least one amplifier, a transceiver, a coupler, a low noise amplifier, a duplexer, and the like. In addition, the RF unit 101 can also communicate with the network and other devices through wireless communication.

Wi-Fi™ is a short-distance wireless transmission technology. Users can send and receive emails, browse web pages, and access streaming media by electronic devices through the Wi-Fi™ module 102, which provides users with wireless broadband Internet access. Although FIG. 1 shows the Wi-Fi™ module 102, it can be understood that it is not a necessary component of the electronic device, and can be completely omitted according to needs without changing the essence of the present disclosure.

The audio output unit 103 can convert the audio data received by the RF unit 101 or Wi-Fi™ module 102 or stored in the memory 109 into an audio signal and output as sound when the electronic device 1 is in a call signal reception mode, a call mode, a recording mode, an voice recognition mode, a broadcast reception mode, etc. Moreover, the audio output unit 103 can also provide audio output related to a specific function performed by the electronic device 1 (e.g., call signal reception sound, message reception sound, etc.). The audio output unit 103 may include a speaker, a buzzer, and the like.

The A/V input unit 104 is configured to receive audio or video signals. The A/V input unit 104 may include a Graphics Processing Unit (GPU) 1041 and a microphone 1042, the GPU 1041 processes image data of still images or videos obtained by image capture devices (such as cameras) in video capture mode or image capture mode. The processed image frame can be displayed on the display unit 106. The image frames processed by the GPU 1041 can be stored in the memory 109 (or other storage medium) or transmitted through the RF unit 101 or Wi-Fi™ module 102. Microphone 1042 can receive sound (audio data) through microphone 1042 in phone call mode, recording mode, voice recognition mode, and other operating modes, and can process the sound into audio data. The processed audio (voice) data can be converted into a format that can be sent to a mobile communication base station through the radio frequency unit 101 for output in telephone call mode. Microphone 1042 can implement various types of noise cancellation (or suppression) algorithms to eliminate (or suppress) noise or interference generated during the reception and transmission of audio signals.

The electronic device 1 also includes at least one sensor 105, such as a light sensor, a motion sensor and other sensors. Specifically, the light sensor includes an ambient light sensor and a proximity sensor, wherein the ambient light sensor can adjust the brightness of the display panel 1061 according to the brightness of the ambient light, and the proximity sensor can turn off display panel 1061 and/or backlight when electronic device 1 is moved to the ear. As a kind of motion sensor, the accelerometer sensor can detect the magnitude of acceleration in various directions (generally three axes), and can detect the magnitude and direction of gravity when it is stationary, and can be used for applications that recognize the posture of mobile phones (such as horizontal and vertical screen switching, related games, magnetometer attitude calibration), vibration recognition related functions (such as pedometer, tap), etc., As for other sensors such as fingerprint sensors, pressure sensors, iris sensors, molecular sensors, gyroscopes, barometers, hygrometers, thermometers, infrared sensors, etc. that can be configured on mobile phones, it will not be described in detail here.

In the embodiment, the electronic device 1 includes a display unit 106.

The user input unit 107 can be used to receive input numbers or character information, and generate key signal input related to user settings and function control of the electronic device. Specifically, the user input unit 107 may include a touch panel 1071 and other input devices 1072. The touch panel 1071, also referred to as a touch screen, can collect touch operations of the user on or near it (for example, the user uses any suitable object or accessory such as a finger and a stylus to operate on the touch panel 1071 or near the touch panel 1071), and drive the corresponding connection device according to the preset program. The touch panel 1071 may include two parts, a touch detection device and a touch controller, wherein the touch detection device detects the user's touch orientation, detects the signal brought by the touch operation, and transmits the signal to the touch controller; the touch controller receives the touch information from the touch detection device, converts it into contact coordinates, and sends it to the processor 110, and can receive and execute commands sent by the processor 110. In addition, the touch panel 1071 can be implemented in various types such as resistive, capacitive, infrared, and surface acoustic wave. In addition to the touch panel 1071, the user input unit 107 may also include other input devices 1072. Specifically, other input devices 1072 may include, but are not limited to, one or more physical keyboards, function keys (such as volume control buttons, switch buttons, etc.), trackballs, mice, joysticks, etc., which are not limited here.

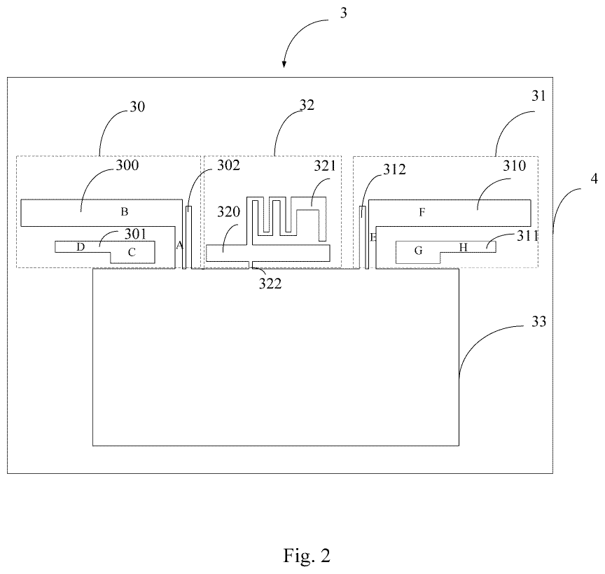

Further, the touch panel 1071 may cover the display panel 1061, and when the touch panel 1071 detects a touch operation on or near it, it transmits to the processor 110 to determine the type of the touch event, then the processor 110 provides corresponding visual output on the display panel 1061 according to the type of the touch event. Although in FIG. 2, the touch panel 1071 and the display panel 1061 are used as two independent components to realize the input and output functions of the electronic device, in some embodiments, touch panel 1071 can be integrated with display panel 1061 to achieve the input and output functions of electronic devices, which are not limited here.

The interface unit 108 is used as an interface through which at least one external device can be connected with the electronic device 1. For example, an external device may include a wired or wireless headset port, an external power (or battery charger) port, a wired or wireless data port, a memory card port, a port for connecting a device with an identification module, audio input/output (I/O) ports, video I/O ports, headphone ports, and more. The interface unit 108 can be used to receive input from external devices (such as data information, power, etc.) and transmit the received input to one or more components within electronic device 1, or can be used to transmit data between electronic device 1 and external devices.

Memory 109 can be used to store software programs and various data. The memory 109 can mainly include a storage program area and a storage data area, wherein the storage program area can store an operating system, an application program required for at least one function (such as sound playback function, image playback function, etc.), etc. The storage data area can store data created based on the use of the phone (such as audio data, phone book, etc.). In addition, memory 109 may include high-speed random access memory, as well as non-volatile memory, such as at least one disk storage device, flash memory device, or other volatile solid-state storage device.

The processor 110 is a control center of the electronic device, connecting various parts of the entire electronic device through various interfaces and circuits. By running or executing software programs and/or modules stored in memory 109, as well as calling data stored in memory 109, various functions of electronic devices and processes data are performed, thereby monitoring the electronic device as a whole. The processor 110 may include one or more processing units. Preferably, the processor 110 can integrate an application processor and a modulation and demodulation processor, wherein the application processor mainly processes the operating system, user interface, and application program, while the modulation and demodulation processor mainly processes wireless communication. It can be understood that the modulation and demodulation processor mentioned above may not be integrated into the processor 110.

The electronic device 1 also includes a power supply 111 for supplying power to various components. The power supply 111 can be logically connected to the processor 110 through the power management system, so that functions such as charging, discharging, and power consumption management can be realized through the power management system.

Although not shown in FIG. 1, the electronic device 1 may also include a Bluetooth™ module to realize data transmission between the electronic device 1 and other external electronic devices.

As shown in FIG. 2, FIG. 2 a structural schematic diagram of an embodiment of an antenna structure 3 of the present disclosure. In the embodiment, the antenna structure 3 can be applied to the electronic device 1 mentioned above. As shown in FIG. 2, the antenna structure 3 is arranged on a substrate 4, including a first antenna 30, a second antenna 31, an isolation element 32, and a grounding part 33. Preferably, the first antenna 30 and the second antenna 31 are Wi-Fi™ antennas. In the embodiment, the first antenna 30 and the second antenna 31 are in a same structure, and the first antenna 30 and the second antenna 31 are symmetrically arranged on both sides of the isolation element 32. It can be understood that the structures of the first antenna 30 and the second antenna 31 can be different.

The first antenna 30 is electrically connected to the grounding part 33 for transmitting and receiving signals. There is a first gap between the first antenna 30 and the grounding part 33, a high-frequency frequency range of 5.15 GHz to 7.125 GHz is resonated through the first gap. The first antenna 30 is also coupled with the isolation element 32 to achieve high-frequency matching effect, thereby achieving broadband effect. Similarly, the second antenna 31 is electrically connected to the grounding portion 33 for transmitting and receiving signals. There is also a second gap between the second antenna 31 and the grounding part 33, a high-frequency frequency range of 5.15 GHz to 7.125 GHz is resonated through the second gap. The second antenna 31 is also coupled with the isolation element 32 to achieve high-frequency matching effect, thereby achieving broadband effect. For example, the first antenna 30 and the second antenna 31 can meet the bandwidth requirements of Wi-Fi™ 6/7 antennas.

The isolation element 32 is arranged between the first antenna 30 and the second antenna 31, and is configured to adjust the bandwidth of the antenna and adjust the current path of the first antenna 30 and the second antenna 31, and a current path direction of the first antenna and a current path direction of the second antenna is opposite, thereby reducing the conduction interference of the ground edge current, increasing the degree of isolation between the first antenna 30 and the second antenna 31, and reducing mutual interference between the first antenna 30 and the second antenna 31.

In the embodiment, the first antenna 30 includes a first radiator 300, a second radiator 301 and a third radiator 302. The first radiator 300 is in a ¬-shape, one end of the first radiator 300 is electrically connected to the grounding part 33 and the other end of the first radiator is suspended. The second radiator 301 is in a degree ¬-shape, the second radiator 301 is half-surrounded by the first radiator 300, and both ends of the second radiator 301 are suspended. The third radiator 302 is in a long strip shape, one end of the third radiator 302 is vertically connected to the ground portion 33, and the other end of the third radiator 302 is suspended.

In the embodiment, the first radiator 300 includes a first part A and a second part B. One end of the first part A is vertically connected to the ground part 33, and the other end of the first part A is vertically connected to one end of the second part B, and other end of the second part B is suspended. The second radiator 301 includes a third part C and a fourth part D. The third part Cis vertically connected to the fourth part D, the third part C is parallel to the first part A, and the fourth part D is parallel to the second part B. The third radiator 302 is parallel to the first part A. There is a first gap between the third part C of the second radiator 301 and the ground part 33, and a high frequency band of 5.15 GHz-7.125 GHz is resonated through the first gap. The third radiator 302 is coupled with the isolation element 32 to achieve a high frequency matching effect.

In the embodiment, the isolation element 32 includes a fourth radiator 320 and a fifth radiator 321. The fourth radiator 320 is in a rectangular shape, and the fourth radiator 320 is vertically connected to the grounding portion 33 through the connecting portion 322. The fifth radiator 321 is in a serpentine shape, one end of the fifth radiator 321 is vertically connected to the fourth radiator 320, and the other end of the fifth radiator 321 is suspended. The length of the fourth radiator 322 is between ½ wavelength and ¼ wavelength, so as to ensure high-frequency degree of isolation.

In the embodiment, the second antenna 31 has the same structure as the first antenna 30 as an example. Then the second antenna 31 includes a sixth radiator 310, a seventh radiator 311 and an eighth radiator 312. The six radiator 310 is in a ¬-shape, one end of the six radiator 310 is electrically connected to the grounding part 33, and the other end of the six radiator 310 is suspended. The seventh radiator 311 is in a ¬-shape, the seventh radiator 311 is half-surrounded by the first radiator 300, and both ends of the second radiator 301 are suspended. The eighth radiator 312 is in a long strip shape, one end of the eighth radiator 312 is vertically connected to the grounding part 33, and the other end of the eighth radiator 312 is suspended.

In the embodiment, the sixth radiator 310 includes a fifth part E and a sixth part F, one end of the fifth part E is vertically connected to the grounding part 33, and the other end of the fifth part E is vertically connected to one end of the sixth part F. The other end of sixth part F is suspended. The seventh radiator 311 includes a seventh part G and an eighth part H, the seventh part G is vertically connected to the eighth part H, the seventh part G is parallel to the fifth part E, and the eighth part H is parallel to the sixth part F. The third radiator 302 is parallel to the fifth part E.

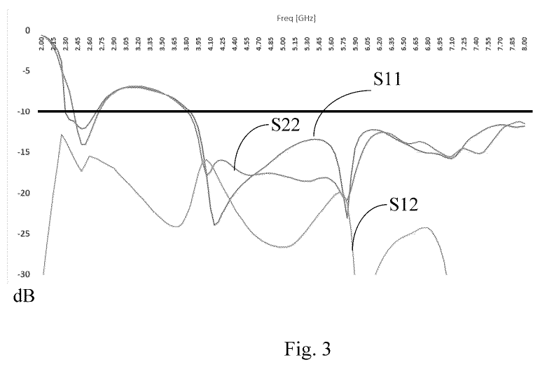

Referring to FIG. 3, FIG. 3 is a schematic diagram of a simulation curve of the return loss of the antenna structure of the present disclosure and the degree of isolation between the first antenna 30 and the second antenna 31. As shown in the figure, the S11 curve is a simulation curve diagram of the S11 parameter of the first antenna 30, combined with Table 1:

TABLE 1
simulation test data of the return loss of the first antenna 30

| first antenna | 2.4 GHz | 2.5 GHz | 5.15 GHz | 5.45 GHz | 5.85 GHz | 6.125 GHz | 7.125 GHz |
|---|---|---|---|---|---|---|---|
| return loss/dB | −11.16 | −12.09 | −14.08 | −13.43 | −17.87 | −12.21 | −15.49 |

The S22 curve is a simulation curve diagram of the S22 parameter of the second antenna 31, combined with Table 2:

TABLE 2
simulation test data of the return loss of the second antenna 31

| second antenna | 2.4 GHz | 2.5 GHz | 5.15 GHz | 5.45 GHz | 5.85 GHz | 6.125 GHz | 7.125 GHz |
|---|---|---|---|---|---|---|---|
| return loss/dB | −9.99 | −14.01 | −18.27 | −18.20 | −19.56 | −12.76 | −15.09 |

The S12 curve is the simulation curve diagram of the degree of isolation of the first antenna 30 and the second antenna 31, combined with Table 3:

TABLE 3
simulation test data of degree of isolation between the first antenna 30 and the second antenna 31

| | 2.4 GHz | 2.5 GHz | 5.15 GHz | 5.45 GHz | 5.85 GHz | 6.125 GHz | 7.125 GHz |
|---|---|---|---|---|---|---|---|
| isolation/dB | −15.66 | −17.33 | −26.14 | −22.56 | −24.52 | −29.96 | −49.81 |

It can be seen from Table 1-Table 3 that in the simulation test, the absolute values of the return loss of the first antenna 30 and the second antenna 31 at different frequencies are greater than 8 dB, and the absolute values of the degree of isolation between the first antenna 30 and the second antenna 31 at different frequencies are greater than 15 dB, so that the first antenna 30 and the second antenna 31 can meet the antenna bandwidth requirements of Wi-Fi™ 6/7 while ensuring antenna performance and degree of isolation between antennas.

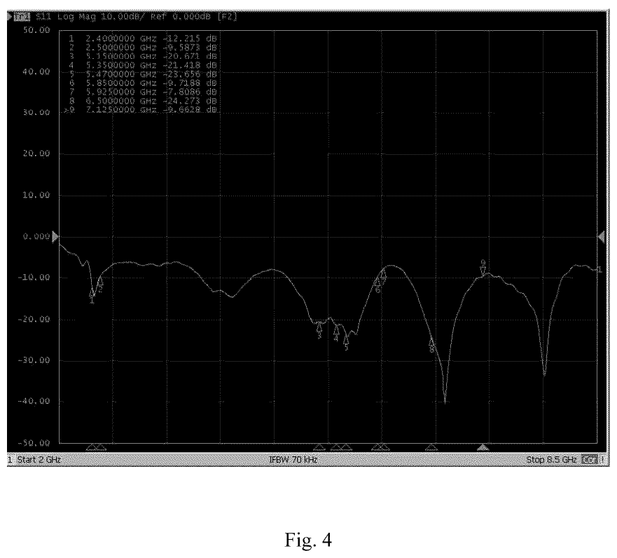

Referring to FIG. 4, FIG. 4 is a schematic diagram of an actual test of the return loss of the first antenna of the antenna structure of the present disclosure. As shown in the figure, in the actual test, the return loss of the first antenna 30 is shown in Table 4:

TABLE 4
actual test data of the return loss of the first antenna 30

| first antenna | 2.4 GHz | 2.5 GHz | 5.15 GHz | 5.45 GHz | 5.85 GHz | 6.125 GHz | 7.125 GHz |
|---|---|---|---|---|---|---|---|
| return loss/dB | −12.21 | −9.58 | −20.67 | −23.65 | −9.71 | −8.83 | −9.66 |

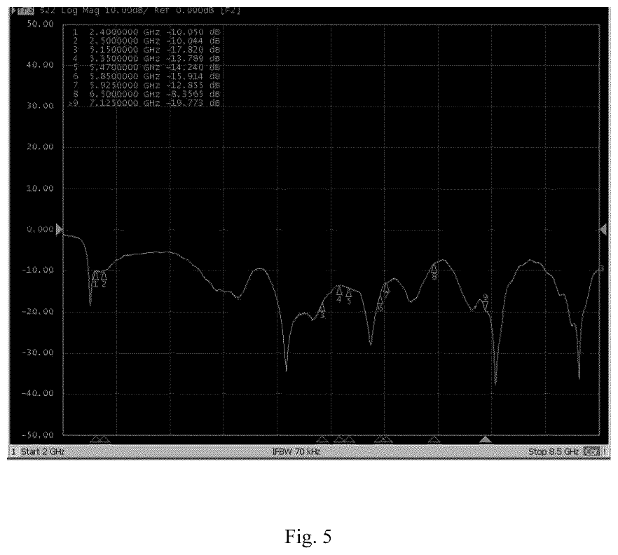

Referring to FIG. 5, FIG. 5 is a schematic diagram of an actual test of the return loss of the second antenna of the antenna structure of the present disclosure. As shown in the figure, in the actual test, the return loss of the second antenna is shown in Table 5:

TABLE 5
Actual test data of the return loss of the second antenna 31

| second antenna | 2.4 GHz | 2.5 GHz | 5.15 GHz | 5.45 GHz | 5.85 GHz | 6.125 GHz | 7.125 GHz |
|---|---|---|---|---|---|---|---|
| return loss/dB | −10.05 | −10.04 | −17.82 | −14.24 | −15.91 | −8.95 | −19.77 |

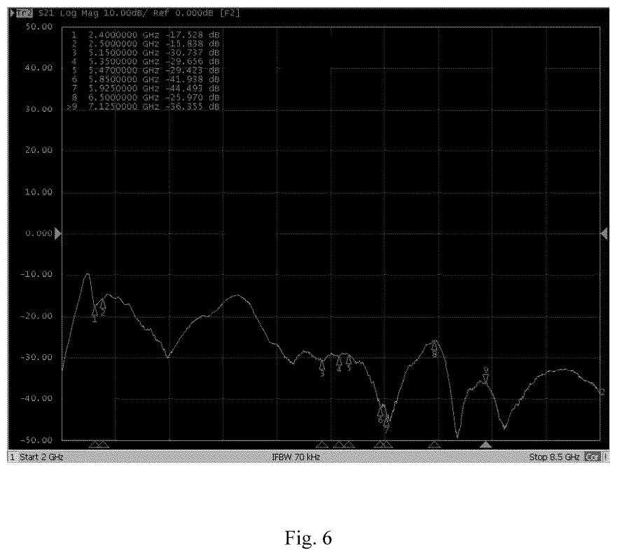

Referring to FIG. 6, FIG. 6 is a schematic diagram of an actual test of the degree of isolation between the first antenna and the second antenna of the antenna structure of the present disclosure. As shown in the figure, in the actual test, the degree of isolation between the first antenna 30 and the second antenna 31 is shown in Table 6:

TABLE 6
actual test data of degree of isolation between the first antenna 30 and the second antenna 31

| | 2.4 GHz | 2.5 GHz | 5.15 GHz | 5.45 GHz | 5.85 GHz | 6.125 GHz | 7.125 GHz |
|---|---|---|---|---|---|---|---|
| degree of | −17.52 | −16.83 | −30.73 | −29.42 | −41.93 | −30.22 | −36.35 |
| isolation/dB | | | | | | | |

As can be seen from Table 4-Table 5, in the actual test, the absolute values of the return loss of the first antenna 30 and the second antenna 31 at different frequencies are greater than 8 dB, and the absolute values of the degree of isolation between the first antenna 30 and the second antenna 31 at different frequencies are greater than 15 dB, so that the first antenna 30 and the second antenna 31 meet the bandwidth requirements of WiFi6/7 antennas while ensuring antenna performance and degree of isolation between the first antenna 30 and the second antenna 31.

Further, in combination with FIG. 4-FIG. 6, the antenna efficiency and gain peak value of the first antenna 30 and the second antenna 31 can be obtained, as shown in Table 7:

TABLE 7
antenna efficiency and peak gain of the first
antenna 30 and the second antenna 31

| | | |
|---|---|---|
| | efficiency of the first | efficiency of the second |
| | antenna (%) / | antenna (%) / |
| frequency | gain peak (dBi) | gain peak (dBi) |

| | | | |
|---|---|---|---|
| 2.40 | GHz | Eff.: 65%, 1.80 dBi | Eff.: 61%, 1.90 dBi |
| 2.50 | GHz | Eff.: 64%, 1.91 dBi | Eff.: 64%, 1.82 dBi |
| 5.15 | GHz | Eff.: 76%, 2.11 dBi | Eff.: 71%, 2.17 dBi |
| 5.45 | GHz | Eff.: 78%, 2.16 dBi | Eff.: 73%, 2.24 dBi |
| 5.85 | GHz | Eff.: 76%, 2.24 dBi | Eff.: 70%, 2.68 dBi |
| 6.125 | GHz | Eff.: 72%, 2.51 dBi | Eff.: 70%, 2.54 dBi |
| 7.125 | GHz | Eff.: 77%, 2.55 dBi | Eff.: 76%, 2.58 dBi |

It can be seen from Table 7 that the efficiencies of the first antenna 30 and the second antenna 31 at different frequencies are both above 61%, and the peak gains are both above 1.80 dBi, meeting the antenna performance requirements.

Compared with the prior art, in the antenna structure provided by the embodiment of the present disclosure, an isolation element is provided between the first antenna and the second antenna, and the bandwidth of the first antenna and the second antenna is adjusted through the isolation element, so that the antenna meets the preset antenna bandwidth requirements and the current path of the first antenna and the second antenna are adjusted, thereby reducing the conduction interference of the ground edge current, increasing the degree of isolation between the first antenna and the second antenna, and reducing the mutual interference between the antennas. The absolute value of the return loss of the first antenna and the second antenna at different frequencies is greater than 8 dB, and the absolute value of the degree of isolation between the first antenna and the second antenna at different frequencies is greater than 15 dB, so that the first antenna and the second antenna can meet the preset antenna bandwidth requirements while ensuring antenna performance and degree of isolation between antennas.

Many details are often found in the relevant art and many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An antenna structure comprising:
a first antenna electrically connected to a grounding part for transmitting and receiving signals;
a second antenna electrically connected to the grounding part for transmitting and receiving signals; and
an isolation element arranged between the first antenna and the second antenna, the isolation element being configured to adjust an antenna bandwidth and a current path between the first antenna and the second antenna such that a degree of isolation between the first antenna and the second antenna is increased.

2. The antenna structure according to claim 1, wherein the first antenna and the second antenna are symmetrically arranged on either side of the isolation element.

3. The antenna structure according to claim 1, wherein the first antenna further comprises:
a first radiator, in a ¬-shape, wherein a first end of the first radiator is electrically connected to the grounding part and a second end of the first radiator is suspended;
a second radiator, in a ¬-shape, wherein the second radiator is half-surrounded by the first radiator, and two ends of the second radiator are suspended;
a third radiator, in a long strip shape, wherein one end of the third radiator is vertically connected to the grounding part and another end of the third radiator is suspended.

4. The antenna structure according to claim 3, wherein
the first radiator comprises a first part and a second part, the first end is defined on one end of the first part and is vertically connected to the grounding part, another end of the first part is vertically connected to one end of the second part, and the second end is defined on another end of the second part;
the second radiator comprises a third part and a fourth part, the third part is vertically connected to the fourth part, the third part is parallel to the first part, and the fourth part is parallel to the second part; and
the third radiator is parallel to the first part of the first radiator.

5. The antenna structure according to claim 4, wherein a first gap is defined between the third part of the second radiator and the grounding part, and a high-frequency range of 5.15 GHz to 7.125 GHz is resonated through the first gap.

6. The antenna structure according to claim 3, wherein the third radiator is coupled with the isolation element to achieve a high-frequency matching effect.

7. The antenna structure according to claim 1, wherein:
a current path direction of the first antenna is opposite to a current path direction of the second antenna.

8. The antenna structure according to claim 1, wherein the isolation element comprises:
a fourth radiator, in a rectangular shape, vertically connected to the grounding part through a connecting part;
a fifth radiator, in a serpentine shape, wherein one end of the fifth radiator is vertically connected to the fourth radiator and another end of the fifth radiator is suspended.

9. An electronic device, comprising an antenna structure, wherein the antenna structure comprises:
a first antenna electrically connected to a grounding part for transmitting and receiving signals;
a second antenna electrically connected to the grounding part for transmitting and receiving signals; and
an isolation element arranged between the first antenna and the second antenna, the isolation element being configured to adjust an antenna bandwidth and a current path between the first antenna and the second antenna such that a degree of isolation between the first antenna and the second antenna is increased.

10. The electronic device according to claim 9, wherein the first antenna and the second antenna are symmetrically arranged on either side of the isolation element.

11. The electronic device according to claim 9, wherein the first antenna further comprises:
a first radiator, in a ¬-shape, wherein a first end of the first radiator is electrically connected to the grounding part and a second end of the first radiator is suspended;
a second radiator, in a ¬-shape, wherein the second radiator is half-surrounded by the first radiator, and two ends of the second radiator are suspended;
a third radiator, in a long strip shape, wherein one end of the third radiator is vertically connected to the grounding part and another end of the third radiator is suspended.

12. The electronic device according to claim 11, wherein
the first radiator comprises a first part and a second part, the first end is defined on one end of the first part and is vertically connected to the grounding part, another end of the first part is vertically connected to one end of the second part, and the second end is defined on another end of the second part;
the second radiator comprises a third part and a fourth part, the third part is vertically connected to the fourth part, the third part is parallel to the first part, and the fourth part is parallel to the second part; and
the third radiator is parallel to the first part of the first radiator.

13. The electronic device according to claim 12, wherein a first gap is defined between the third part of the second radiator and the grounding part, and a high-frequency range of 5.15 GHz to 7.125 GHz is resonated through the first gap.

14. The antenna structure according to claim 11, wherein the third radiator is coupled with the isolation element to achieve a high-frequency matching effect.

15. The antenna structure according to claim 9, wherein:
a current path direction of the first antenna is opposite to a current path direction of the second antenna.

16. The antenna structure according to claim 9, wherein the isolation element comprises:
a fourth radiator, in a rectangular shape, vertically connected to the grounding part through a connecting part;
a fifth radiator, in a serpentine shape, wherein one end of the fifth radiator is vertically connected to the fourth radiator and another end of the fifth radiator is suspended.
